(19) United States
(12) Patent Application Publication
(10) Pub. No.: US 2024/0248590 A1
(43) Pub. Date: Jul. 25, 2024

(54) CLOUD SERVICE PLATFORM INTEGRATION WITH DEALER MANAGEMENT SYSTEMS

(71) Applicant: CDK GLOBAL, LLC, Hoffman Estates, IL (US)

(72) Inventors: Abhijeet Pai, Beaverton, OR (US); Will Padron, Pembroke Pines, FL (US); Daniel Green, Albany, OR (US); Bruce Suitor, Rockville, MD (US); Ethan Heusser, Portland, OR (US); Northon Rodrigues, Oregon City, OR (US); Akshay Mishra, Hyderabad (IN); Yash Kumar Sharma, Hyderabad (IN); Abinay Muppidi, Telangana (IN); Sai Priya Katkam, Telangana (IN); Winn Davis, Houston, TX (US)

(21) Appl. No.: 18/626,225

(22) Filed: Apr. 3, 2024

Related U.S. Application Data
(62) Division of application No. 17/661,875, filed on May 3, 2022.

(51) Int. Cl. G06F 3/04842; G06F 9/50; G06F 16/27

(52) U.S. Cl. CPC G06F 3/04842; G06F 9/5072; G06F 16/27

(57) ABSTRACT

Systems and methods for network-based cloud service platform integrations with dealer management systems (DMS) are disclosed herein. A cloud service platform may integrate over the network with an instance of a DMS used by an end user. The cloud service platform may define fields that can be used in conjunction with forms useable with the DMS, and may be further capable of storing field data for those fields. The cloud service platform may provide a graphical user interface (GUI) prompt to a user of the DMS to provide the field data. A form using the fields defined at the cloud service platform may be provided to the cloud service platform and filled at the cloud service platform using field data for those fields stored at the cloud service platform. The form may then be provided to a print service for presentation to the user.

### RELATED APPLICATIONS

This application claims priority to U.S. patent application Ser. No. 17/661,875, filed May 3, 2022 and titled CLOUD SERVICE PLATFORM INTEGRATION WITH DEALER MANAGEMENT SYSTEMS, which is incorporated herein by reference in its entirety.

### BACKGROUND

Dealer management systems (DMSs) used by automotive dealers (herein sometimes referred to as “dealers”) to manage workflow and other aspects involving the sale and/or purchasing of automotive inventory, among other aspects. A DMS may be, for example, a software service accessed by various users related to the operation the dealership in order to accomplish these workflows through/with the assistance of the DMS.

### BRIEF SUMMARY

A cloud service platform may integrate over a network with an instance of a DMS used by an end user. The cloud service platform may define various fields that can be used in conjunction with forms that are used by the DMS, and may be further capable of storing field data for those fields. The cloud service platform may provide a graphical user interface (GUI) prompt to a user of the DMS to provide the field data. A form using the fields defined at the cloud service platform may be provided to the cloud service platform by the DMS and filled at the cloud service platform using field data for those fields stored at the cloud service platform. The form may then be provided to the user of the DMS.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a transaction screen of a DMS, according to an embodiment.

FIG. 2 illustrates a DDJ generated by a print service, according to an embodiment.

FIG. 3 illustrates a system for cloud management of field usage at a DMS, according to an embodiment.

FIG. 4 illustrates a field definition GUI for defining a field at a cloud service platform, according to an embodiment

FIG. 5 illustrates a defined fields GUI showing field definitions present at a cloud service platform, according to an embodiment.

FIG. 6 illustrates a field fill GUI used by a user of a DMS to fill in fields defined at the cloud service platform as part of a workflow at a DMS, according to an embodiment.

FIG. 7A and FIG. 7B together illustrate a form GUI for a form that uses fields defined at the cloud service platform, according to an embodiment.

FIG. 8 illustrates a form library GUI that may be displayed to a user of a DMS, according to an embodiment.

FIG. 9 illustrates a DMS prompt GUI that may displayed to a user of the DMS, according to an embodiment.

FIG. 10 illustrates a form preparation summary GUI, according to an embodiment.

FIG. 11 illustrates a DDJ generated at a print service, according to an embodiment.

FIG. 12 illustrates a method of a cloud service platform for integrating with a local application operating on a remote device, according to an embodiment.

FIG. 13 illustrates a method of a cloud service platform for integrating with a local application operating on a remote device, according to an embodiment.

FIG. 14 comprises a method of a cloud service platform for integrating with a local application operating on a remote device, according to an embodiment.

### DETAILED DESCRIPTION

In some cases, a DMS may be useable to prepare and/or manage one or more forms (e.g., physical forms and/or electronic forms) that relate to a transaction (such as a purchase, sale, and/or lease; repair order; recall modification; etc.) about an automobile that occurs at dealership. A collection of such forms as they relate to a same transaction may be referred to herein as a “digital deal jacket” (DDJ). The relevant forms of the DDJ prepared and/or managed by/within the DMS may then be presented to the corresponding relevant parties (e.g., the dealership, the vehicle purchaser/seller/lessee, and/or any other related third parties such as insurers, financers, and/or governmental entities) for execution such that the transaction involving the vehicle can be effectuated.

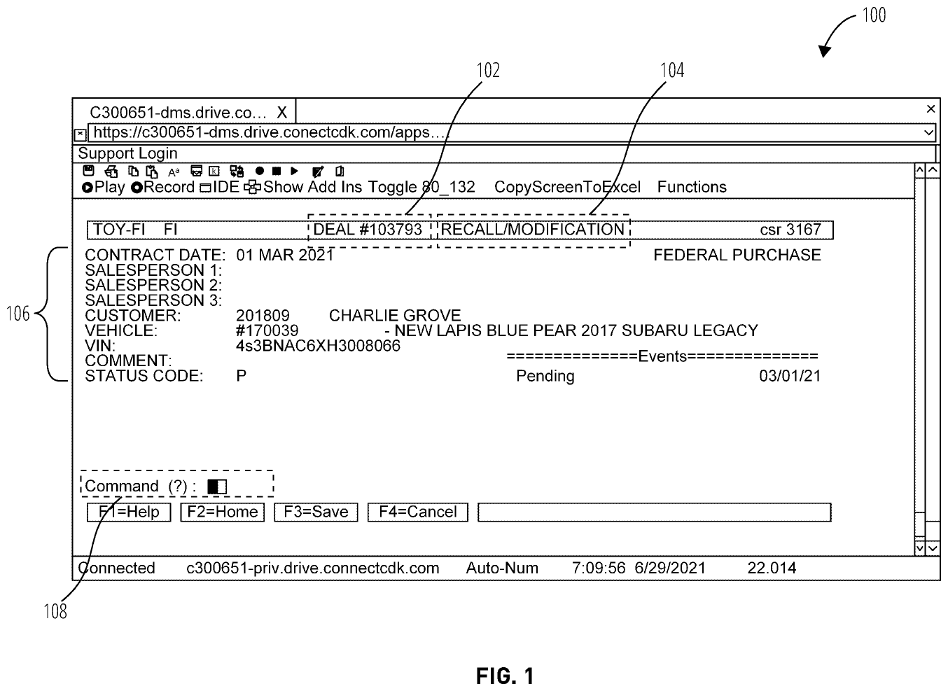

FIG. 1 illustrates a transaction screen 100 of a DMS, according to an embodiment. The transaction screen 100 may be presented to the user of a DMS in order to operate one or more workflows relative to a transaction or deal being managed by the DMS (and for which the DMS is being used to generate one or more forms of a related DDJ).

The transaction screen 100 includes, among other things, the transaction identifier 102, the transaction type 104, the transaction information 106, and the command prompt 108. The transaction identifier 102 may report a unique identifier for the current deal which is currently being operated on via the DMS.

The transaction type 104 reports a type for the present transaction. In the example of FIG. 1, the transaction type 104 is for a purchase (by the customer) of a vehicle, but other deal types (purchase by the dealership, lease by the dealership, etc.) could also be reflected in this field in appropriate corresponding cases.

The transaction information 106 related information about the transaction and/or about the vehicle that is the subject of the transaction. The transaction information 106 could include information beyond the information illustrated in FIG. 1 in alternative embodiments.

The command prompt 108 is provided to allow the user of the DMS to issue commands to the DMS. For example, it may be that the command prompt 108 could be used to instruct the DMS to generate a DDJ for the transaction, using the appropriate forms related to this transaction type and any field information know to the DMS corresponding to those forms. In some cases, this type of instruction may be given by, for example, the user of the DMS entering a “pf” command into the command prompt 108.

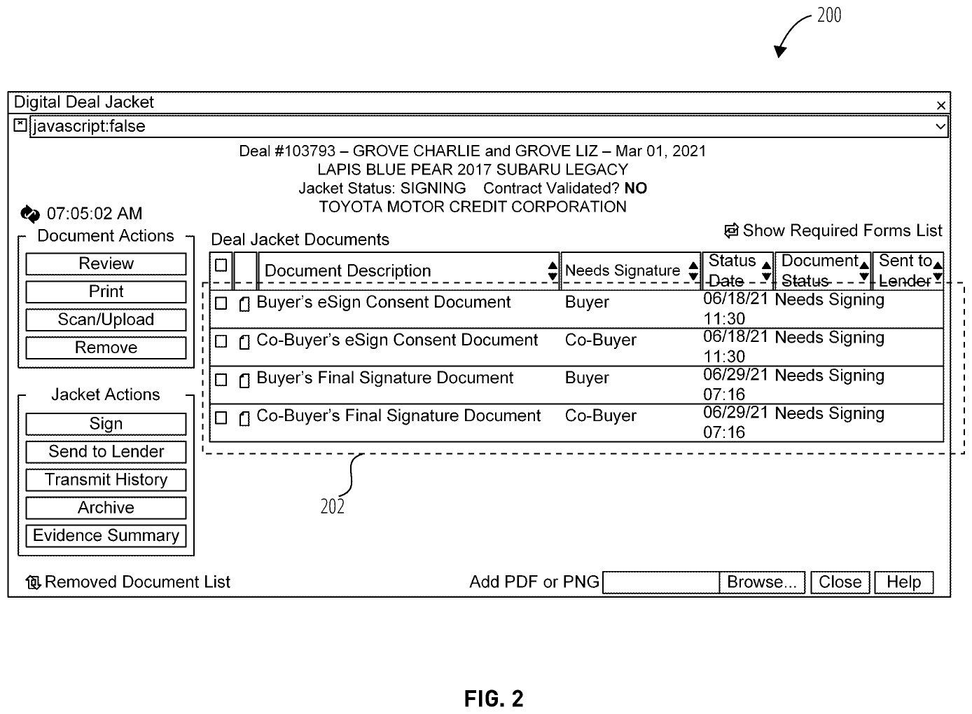

FIG. 2 illustrates a DDJ 200 generated at a print service, according to an embodiment. The DDJ 200 may be related to the transaction illustrated in the transaction screen 100 of FIG. 1. The print service may be a service provided at or by the DMS.

As illustrated, the DDJ 200 includes various forms 202. The forms 202 may be forms that use one or more fields known to the DMS. In other words, once appropriate field data (e.g., data for a field known to the DMS as entered by a user corresponding to a particular transaction) has been entered into the DMS for the fields known to the DMS, the DMS may automatically fill the forms based on the applications of the appropriate field data to the appropriate location on the form.

For example, if one of the forms 202 needs to be filled with the name of a buyer, and a field for the name of the buyer is present in the appropriate field of the DMS for the name of the buyer, the DMS may fill the form with the name of the buyer in the appropriate location prior to/upon presenting the form to a print service for inclusion as part of the DDJ 200 illustrated here.

DMS systems may support information input necessary to generate one or more forms through the use of user-enterable fields. These fields may relate to a wide variety of information that may be related to a transaction involving an automobile at a dealership operating the DMS. For example, the DMS may use fields for items of personal information for a purchaser/seller/lessee (e.g., names, birthdate, social security number, driver's license information, etc.), for insurance information for an automobile being sold/leased, financing institution information in the case financing is being used, payment processing information related to a given source of funds for effectuating the transaction, etc. Note that some or all of these (and many other) possibilities for information relevant to a transaction involving a vehicle may be enterable into a corresponding field managed by the DMS in various cases.

It has been recognized that, from time to time, it may become desirable to cause the DMS to function with additional fields (e.g., with one or more fields with which it is not currently configured to use). For example, a form used by the DMS may be changed to require a new and/or a different type of information that is not represented by any present field used by the DMS, and/or it may be that a new form is designed for the use with the DMS that requires or otherwise uses such new and/or different type of information that is not represented in any present field used by the DMS.

It has further been recognized that simply adding fields to a DMS directly can result in downstream issues. For example, because of the unknowable nature of the particular type of fields that may later be needed, some DMS systems are provided with (at the time of DMS instantiation) optional “auxiliary” fields that may be used by the dealership as such new fields as it becomes necessary to provide additional types of information to the DMS. However, these auxiliary fields of a DMS may be limited in various ways. For example, due to the “canned” nature of the these auxiliary fields, it may become ultimately necessary to rely on individual institutional knowledge (e.g., within the particular dealership) regarding what type of information is present in a given auxiliary field of that dealership's DMS instance. Further, multiple different dealerships may use different auxiliary fields of their respective instances of the DMS for different types of information, meaning that there is no guarantee of cross-entity consistency for auxiliary field use across different dealerships' instances of the DMS. This may make understanding the any auxiliary field of any particular DMS instance more difficult for entities that may work across such DMS instances, such as providers of the DMS software.

Other problems may arise in the case where auxiliary field usage at the DMS as has been described is not sufficient/suitable. This may occur, for example, in the case where many new fields are needed (e.g., in the case of expanding the DMS functionality to work with an additional form having these many new fields). In such cases, it may be that the DMS itself could be expanded to account for the fields of the new form (e.g., to fully integrate the new fields into the DMS, rather than using the limited number of auxiliary fields). In such cases, it may be necessary for a provider of the DMS software to modify the DMS instance used by the dealership to accordingly integrate the new fields. This represents additional burden for the DMS provider (particularly when considering that the provider may support multiple DMS instances across multiple dealerships that may each desire different changes of this kind).

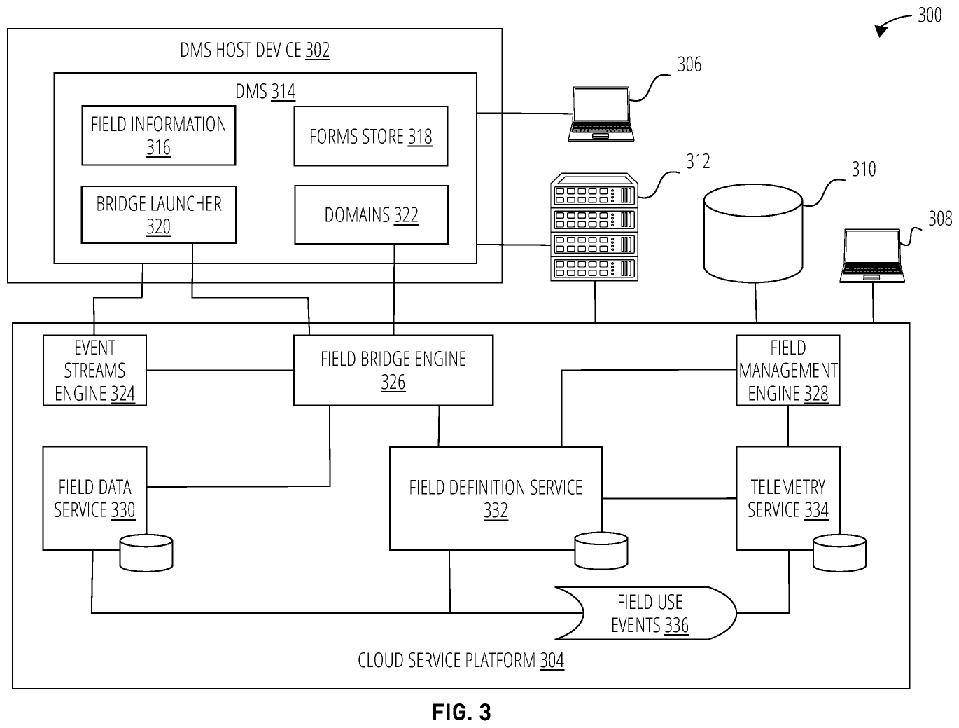

FIG. 3 illustrates a system 300 for cloud management of field usage at a DMS, according to an embodiment. As illustrated, the system 300 includes a DMS host device 302, a cloud service platform 304, a first user device 306 (that is in communication with a DMS 314 on the DMS host device 302), a second user device 308 (that is in communication with the cloud service platform 304), a forms database 310 (that is in communication with the cloud service platform 304), and a print service 312 (that is in communication with each of the DMS host device 302 and the cloud service platform 304).

The DMS host device 302 may be a host device for an instance of a DMS 314 being used by a dealership.

The DMS 314 may include the field information 316. This field information 316 may correspond to one or more fields (including auxiliary fields) of the DMS 314 that is for one or more transactions being managed at the DMS 314 (e.g., as entered at some point into the DMS 314 by a user of the DMS 314 using the first user device 306 connected to the DMS host device 302 hosting the DMS 314), as described herein. The field information 316 may include/reflect definitions for such fields. The field information 316 may also include field data (e.g., as has been entered by a user of the first user device 306) for such fields.

The DMS host device 302 may further include a forms store 318. The forms store 318 may include one or more forms with which the DMS 314 is to operate.

The DMS 314 (or the DMS host device 302) may keep a record of any domains 322 used by the DMS 314. The domains 322 may correspond to and/or describe contexts for transactions that the DMS 314 is configured to operate for/handle. Examples of such domains may be a “deal” domain corresponding to the sale and/or purchase of a vehicle, a “repair” domain corresponding to a repair of the vehicle, a “credit” domain corresponding to a use of credit associated with an transaction, etc.

The fields used by the DMS may be associated with one or more of these domains (e.g., such that they are useable within their assigned domains). For example, fields related to the “credit” domain may include a field for the term of a loan, a field for the vehicle mileage, a field for a loan amount, etc.

The domains 322 useable with the DMS 314 may each use subcategories. For example, a “deal” domain may use a “finance institution” subcategory, a “buyer” subcategory, etc. Further, the use of subcategories under a domain may be layered. For example, the “buyer” subcategory may use an “InsuranceInformation” layer. These (layers of) subcategories accordingly act to categorize a field within its domain.

The DMS 314 includes a bridge launcher 320. The bridge launcher 320 may be a software interface between the DMS host device 302 and the cloud service platform 304. The bridge launcher 320 may be capable of providing the cloud service platform 304 with information from the DMS 314 (e.g., such as information from the field information 316 and/or the forms store 318) that is needed at the cloud service platform 304 for the operations of the cloud service platform 304, as will be described. The bridge launcher 320 may also be capable of receiving information at the DMS 314 from the cloud service platform 304.

The bridge launcher 320 may also be capable of displaying graphical user interfaces (GUIs) provided from the cloud service platform 304 to the user of the DMS 314 such that the user can interact with the cloud service platform 304 via the DMS 314.

The bridge launcher 320 may be capable of launching (e.g., beginning a process flow with) a field bridge engine 326 of the cloud service platform 304 (e.g., by sending a signal to the cloud service platform 304).

The cloud service platform 304 is a platform that is in communication (e.g., network communication) with the DMS host device 302 and which can interact with the DMS 314 hosted on the DMS host device 302.

The cloud service platform 304 may be used to expand upon the functionalities of the DMS 314. For example, the cloud service platform 304 may be configured to address issues regarding field use limitations that may exist at the DMS 314, as these are described herein. The cloud service platform 304 may be used to provide additional fields for use with the DMS 314 (e.g., beyond those that are provided directly within the DMS 314). Further, the cloud service platform 304 may communicate with the DMS 314 to provide for/enable the use of these additional fields (at the cloud service platform 304) in conjunction with the DMS 314. The cloud service platform 304 may accordingly help to overcome the problems discussed herein related to the difficulties and disadvantages of (instead) adding additional fields directly to the DMS 314.

The cloud service platform 304 includes an event streams engine 324, a field bridge engine 326, a field management engine 328, field data service 330, a field definition service 332 and a telemetry service 334.

The event streams engine 324 may receive data from the DMS 314, as illustrated. This data may include a form from the DMS 314 that is to be filled (at least in part) at the cloud service platform 304. This data may further include metadata for the fields of the form that is provided to the DMS 314. This data may further include field data for fields of the form that was already known to the DMS 314 and was filled to the form by the DMS 314 prior to the delivery of the form to the event streams engine 324.

Alternatively and/or additionally, the event streams engine 324 may receive a form from the forms store 318. The forms store 318 may include information about one or more forms operable within the cloud service platform 304. After retrieval, the cloud service platform 304 may be capable of filling one or more fields of the form, as described herein. Further, the cloud service platform 304 may be further capable of sending the form to the DMS 314 so that the DMS 314 can fill out further fields (e.g., fields that are managed at the DMS 314 instead of the cloud service platform 304).

The field bridge engine 326 communicates with the bridge launcher 320 of the DMS 314. In some cases, the field bridge engine 326 may operate in response to a signal from the bridge launcher 320. This signal from the bridge launcher 320 may have been generated via an operation of the bridge launcher 320 by a user of the DMS 314.

The field bridge engine 326 may receive and/or send information to/from the bridge launcher 320 of the DMS 314. Information that is sent to the bridge launcher 320 from the field bridge engine 326 may include a GUI having field label information and a field data input mechanism for a field of the cloud service platform 304. This field label information may be presented as part of the GUI as part of an integration of the GUI into a relevant workflow of the DMS 314. The field bridge engine 326 may also send field data that is known to the cloud service platform 304 to the DMS 314 (e.g., for display in the GUI, if it is the case that field data for the relevant field of the cloud service platform 304 already exists when generating the GUI).

The field bridge engine 326 may receive field information from the bridge launcher 320. This field information may be, for example, field data for a field that is defined and/or stored at the DMS 314.

As illustrated, the DMS 314 may provide information regarding the domains 322 to the field bridge engine 326. Once received at the field bridge engine 326, any field definitions created at the cloud service platform 304 for use with the DMS 314 can be assigned corresponding domain(s) that are consistent with the domains used at the DMS 314 (such that domain-wise organization of the fields is preserved and can be used across both the DMS 314 and the cloud service platform 304).

The field bridge engine 326 also communicates with the field data service 330 and the field definition service 332. The field bridge engine 326 may work with the field definition service 332 to retrieve field definition data as needed (e.g., such that the GUI prompting a user to enter field data corresponding to the field definition may be created at the field bridge engine 326 for providing to the bridge launcher 320).

The field bridge engine 326 may store and/or retrieve field data from the field data service 330. For example, in cases where the field bridge engine 326 provides a GUI to the bridge launcher 320 for entry of field data for a field of the cloud service platform 304, the field data may be entered by a user of the DMS 314 into the GUI via the first user device 306 and then communicated from the DMS 314 back to the field bridge engine 326. This field data may then be stored by the field bridge engine 326 in the field data service 330. In some cases where field data for the field is already known at the field data service 330, it may be retrieved by the field bridge engine 326 and pre-provided in the GUI.

The field bridge engine 326 may receive a form from the event streams engine 324 (e.g., that was provided to the event streams engine 324 by the DMS 314). The field bridge engine 326 may then use retrieved field data to fill in one or more fields of the form. The field data may be retrieved from the field data service 330 of the cloud service platform 304, from the DMS 314 (in the case that the DMS 314 stores the field in the field information 316 and has not already filled in the field on the form), and/or a user of the first user device 306 (in the event that neither the cloud service platform 304 nor the DMS 314 has the field data). This may be done by matching an indication of the metadata for the fields of the form (e.g., as was provided to the event streams engine 324 by the DMS 314) to the metadata for the retrieved field data (e.g., as defined in the field definition service 332). For example, the metadata for the retrieved field data may match a field definition for the field that is an XSD file that is used to map fields to forms. Such an XSD file may be stored at the forms database 310 and provided to the cloud service platform 304 for the uses discussed herein from the forms database 310.

The field management engine 328 may be operated by a user of the cloud service platform 304. A user of the cloud service platform 304 (which may be the same or a different user than the user of the DMS 314) may control the cloud service platform 304 via the second user device 308. (or, alternatively, by using the first user device 306).

The field management engine 328 may be used to define fields used by the system 300 and store them into the field definition service 332. For example, a user of the cloud service platform 304 may define metadata for the field, such as a type of data that is stored in the field, a label for the field, a domain of the field, etc. This may be done by, for example, a user of the second user device 308 that is, for example, managing the cloud service platform 304 directly. Some or all of this metadata may be added by the field management engine 328 to an XSD file that is used to map fields to forms within the system 300.

The field management engine 328 may also provide generated field definitions to the telemetry service 334, such that the telemetry service 334 is enabled to recognize the use of fields so defined at the cloud service platform 304.

The field data service 330 may store and/or provide field data for fields of the cloud service platform 304 to other elements of the cloud service platform 304, as is described herein. Further, the field data service 330 may work in conjunction with the field definition service 332 to report any field use events 336 to the telemetry service 334. For example, the field data service 330 may indicate to the telemetry service 334 that a field has been used when the field is used.

The field definition service 332 may store field definitions for fields of the cloud service platform 304. A field definition may include, among other things, metadata for the field such as a type of data that is stored in the field, a label for the field, a domain of the field, etc. These definitions may be stored and/or provided to other elements of the cloud service platform 304 as is described herein.

Further, the field definition service 332 may work in conjunction with the field data service 330 to report any field use events 336 to the telemetry service 334. As part of this process, the field definition service 332 may provide field definitions to the telemetry service 334 to enable the telemetry service 334 to recognized fields that are used.

The telemetry service 334 may store records of how the fields of the cloud service platform 304 are used (e.g., where they are used, how often they are used, etc.). The telemetry service 334 may be capable of presenting these records for review by a user of the cloud service platform 304.

The print service 312 may receive one or more forms from either/both of the DMS 314 and/or the cloud service platform 304 and arrange them within a DDJ, as has been described.

The print service 312 may further handle the output (printing, downloading, etc.) of the DDJ to a user (e.g., via the DMS 314 and to the first user device 306).

It is noted that while the print service 312 has been illustrated in the embodiment of FIG. 3 as separate from the DMS host device 302 and the cloud service platform 304, in some embodiments it may be the case that the print service 312 is instead part of the DMS 314 of the DMS host device 302, or otherwise hosted at the DMS host device 302. In such cases, the interactions of the cloud service platform 304 with the print service 312 as described herein may occur via the DMS 314.

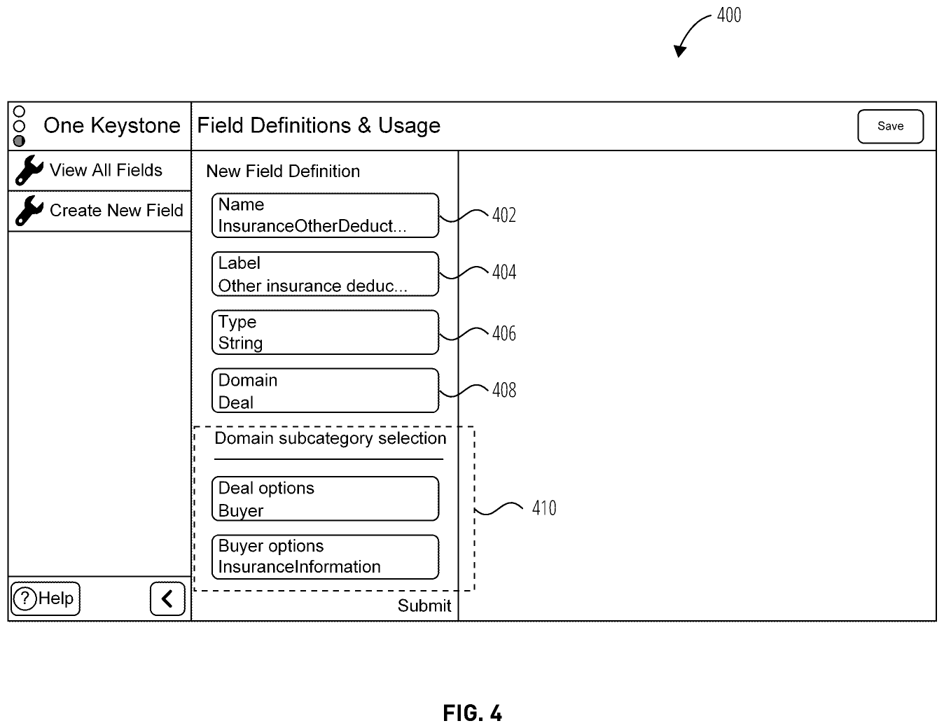

FIG. 4 illustrates a field definition GUI 400 for defining a field at a cloud service platform, according to an embodiment. This field definition GUI 400 may be generated by the field management engine 328 and presented to a user of the second user device 308. In other embodiments, the field definition GUI 400 may instead be presented (via the DMS 314) to a user of the first user device 306. As the field definition GUI 400 is used and submitted back to the field management engine 328, the field management engine 328 may work with the field definition service 332 to store the new field as defined by user input in the field definition GUI 400 at the field definition service 332 for use with the cloud service platform 304.

The field definition GUI 400 allows the user to enter a field name 402. The field name 402 may be used in the system 300 to identify the field within the system 300. In this case, the user has entered “InsuranceOtherDeductibleName” as the field name 402.

The field definition GUI 400 allows the user to enter a field label 404. The field label 404 may be a label that is presented to a user (e.g., of the first user device 306) when the field is used. In this case, the user has entered “Other insurance deductible name, if any:” as the field label 404.

The field definition GUI 400 allows the user to indicate a data type 406 of the field. This data type 406 defines the type of data that can be entered into the field by users of the field. In this case, the user has entered indicated that the field has a data type 406 of “String.”

The field definition GUI 400 allows the user to indicate a domain 408 of the field. This domain may be one of the domains known to the DMS 314 (e.g., that is one of the domains 322 of the DMS 314, as has been communicated to the cloud service platform 304). In this case, the user has entered indicated that relevant domain 408 is “Deal.”

The field definition GUI 400 allows the user to indicate one or more domain subcategory selections 410. These domain subcategory selections 410 may be used to further organize the field within the cloud service platform 304 corresponding to the provided domain 408. At a first layer, the user selected “Buyer” as the subcategory option directly under the domain level of “Deal” (as previously selected by the user as described). In response to the selection of “Buyer,” the field definition GUI 400 presents the “Buyer options” selection option, to which the user selects “InsuranceInformation” as illustrated. Accordingly, an appropriate set of layered subcategories for this new field within the “Deal” domain is established (e.g., Deal/Buyer/InsuranceInformation).

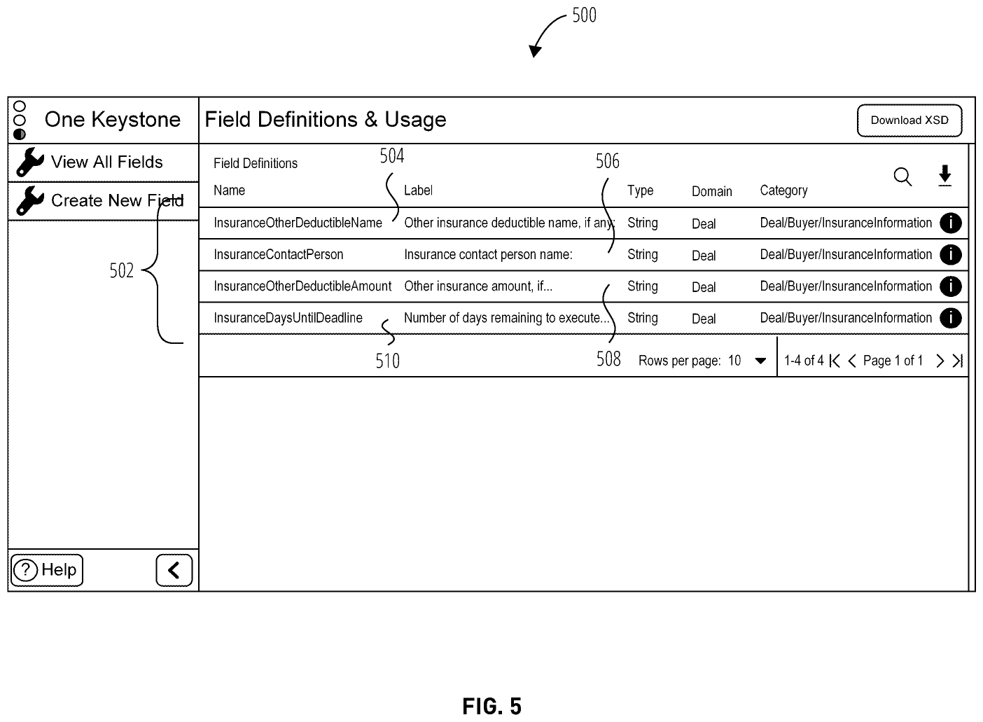

FIG. 5 illustrates a defined fields GUI 500 showing field definitions present at a cloud service platform 304, according to an embodiment. This defined fields GUI 500 may be generated by the field management engine 328 and presented to a user of the second user device 308.

After fields are defined to the cloud service platform (e.g., in the manner described in relation to FIG. 4), the defined fields GUI 500 may be used to review the field definitions 502.

As can be seen, the defined fields GUI 500 illustrates, among others, the first field definition 504. The first field definition 504 represents the particular field definition provided to the cloud service platform 304 by the field definition GUI 400 as discussed by way of example in FIG. 4—as can be seen, this name of this field is “InsuranceOtherDeductibleName,” the label associated with the field is “Other insurance deductible name, if any:”, the associated data type is “String,” the domain is “Deal,” and the set of layered subcategories within the Deal domain is expressed as “Deal/Buyer/InsuranceInformation.”

The second field definition 506, third field definition 508 and fourth field definition 510 of the field definitions 502 are also seen here, as these have been defined to the cloud service platform 304 (e.g., by a user using a field definition GUI similar to the field definition GUI 400 given by way of example in FIG. 4).

A user may click one of the field definitions 502 in order to modify it. In such a case, the field definition GUI (such as described in FIG. 4) is populated with the current information and provided to the user, and can be used by the user to effectuate any desired changes to that field definition.

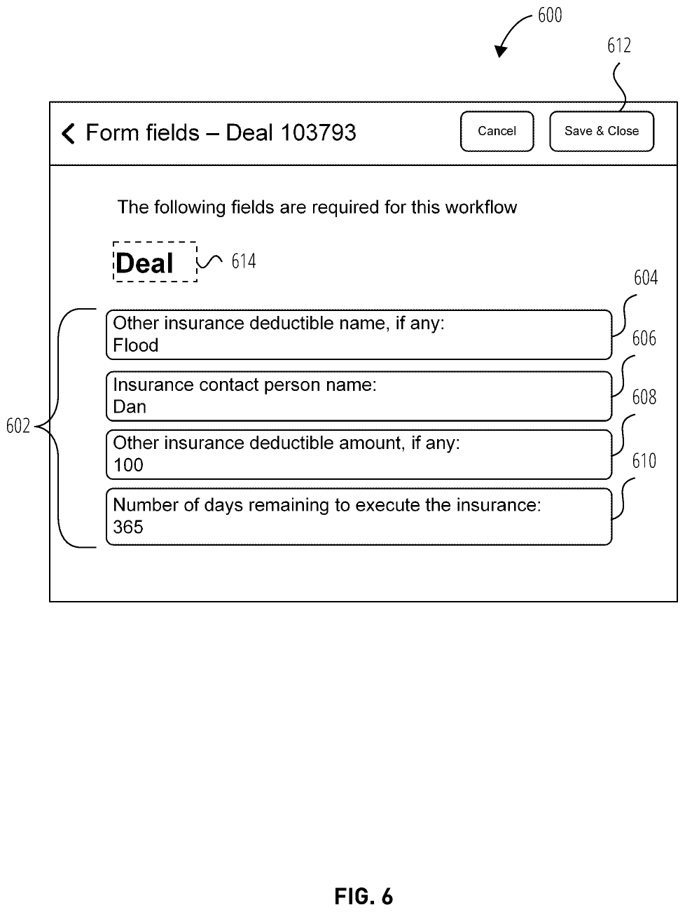

FIG. 6 illustrates a field fill GUI 600 used by a user of a DMS 314 to fill in fields defined at the cloud service platform 304 as part of a workflow at a DMS 314, according to an embodiment. As is described herein, the cloud service platform 304 (e.g., using a field bridge engine 326) may provide the field fill GUI 600 to the bridge launcher 320 of the DMS 314. From there, the field fill GUI 600 may be provided to the user of the DMS 314 at a first user device 306. This field fill GUI 600 may act as a prompt to the user to provide field data to the system 300.

As illustrated, the field fill GUI 600 provides a number of fields 602 for the user to fill in. These fields 602 may correspond to field definitions present at the cloud service platform 304. For example, as will be seen upon review, the fields 602 of FIG. 6 correspond to the field definitions 502 of FIG. 5.

As a more particular example, it will be seen that the first field 604 corresponds to the first field definition 504 of FIG. 5. As can be seen, upon presentation to the user of the DMS 314, the first field 604 is presented with the label “Other insurance deductible name, if any:” as is provided per the first field definition 504. The user has inputted the string “Flood” as field data for the first field 604 consistent with the field type of “String” corresponding used by the first field definition 504.

Upon referencing FIG. 5, it will be seen that each of the second field 606, the third field 608, and the fourth field 610 correspond to the remainder of the field definitions 502 of FIG. 5 (other than the first field definition 504) in an analogous manner. The second field 606 corresponds to the second field definition 506 and accordingly uses the label “Insurance contact person name:”. Here, the user has provided the string value “Dan” as field data. The third field 608 corresponds to the third field definition 508 and accordingly uses the label “Other insurance deductible amount, if any:”. Here, the user has provided the string value “100” as field data. The fourth field 610 corresponds to the fourth field definition 510 and accordingly uses the label “Number of days remaining to execute the insurance:”. Here, the user has provided the string value “365” as field data.

As illustrated, the fields 602 may be organized according to the one or more domains for those fields 602. For example, in FIG. 6, the fields 602 are organized per the “Deal” domain 614 (to which they all belong, as can be seen in reference to the first field definition 504, the second field definition 506, the third field definition 508, and the fourth field definition 510 of FIG. 5).

Once the field fill GUI 600 is filled in by the user, the field data may be taken from the field fill GUI 600 in order to be used with one or more forms that uses the fields 602 for which the field data was provided, as described herein. This action may be initiated by the user clicking the button 612 or taking some other action with the system that is configured to indicate to the system that the filling of the fields 602 by the user has been performed.

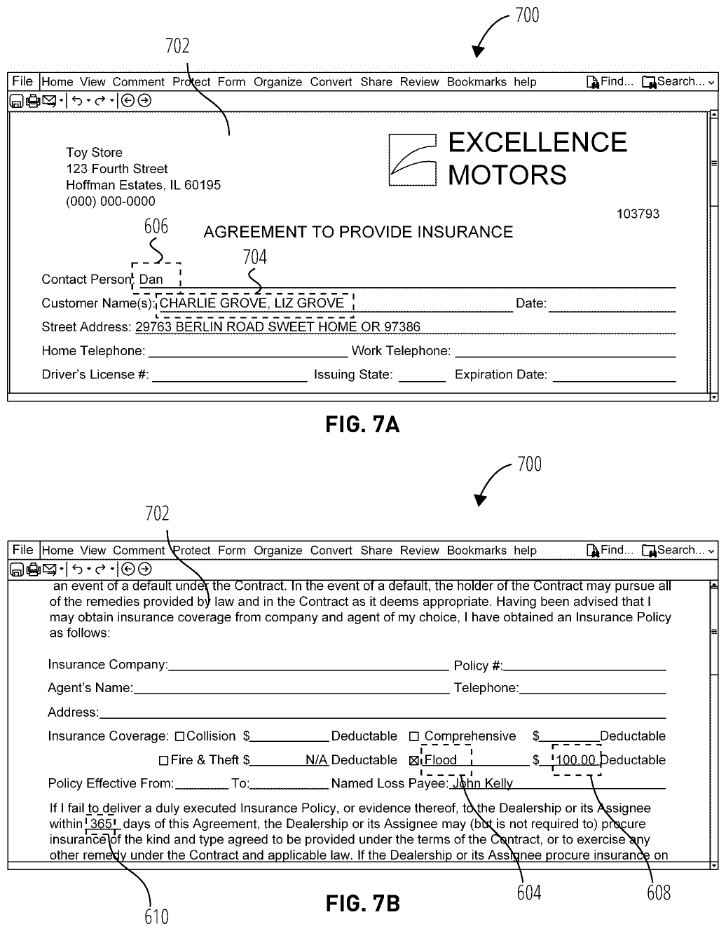

FIG. 7A and FIG. 7B together illustrate a form GUI 700 for a form 702 that uses fields defined at the cloud service platform 304, according to an embodiment. FIG. 7A and FIG. 7B each show the form GUI 700 as scrolled to a different location of the form 702. The form 702 may be received at the cloud service platform 304 from the DMS 314.

The form 702 uses the first field 604, the second field 606, the third field 608, and the fourth field 610 from the cloud service platform 304 in the indicated locations. As can be seen, the user provided field data corresponding to each of these fields (e.g., as was provided by way of example in FIG. 6) has been added to the form 702 (e.g., by the cloud service platform 304) in the corresponding locations. This may be performed by determining that there are XSD definitions corresponding to the first field 604, the second field 606, the third field 608, and the fourth field 610 that map to the form at the indicated locations.

It is noted that the form 702 may also use fields that are defined by the DMS directly (and that have relevant field data stored directly at the DMS). For example, DMS-stored field data (corresponding to fifth field 704 for customer name(s) that is defined at the DMS) has been used in the form 702. This fifth field 704 may have been filled in the form 702 by the DMS 314 separately from (e.g., prior to) any involvement by the cloud service platform 304.

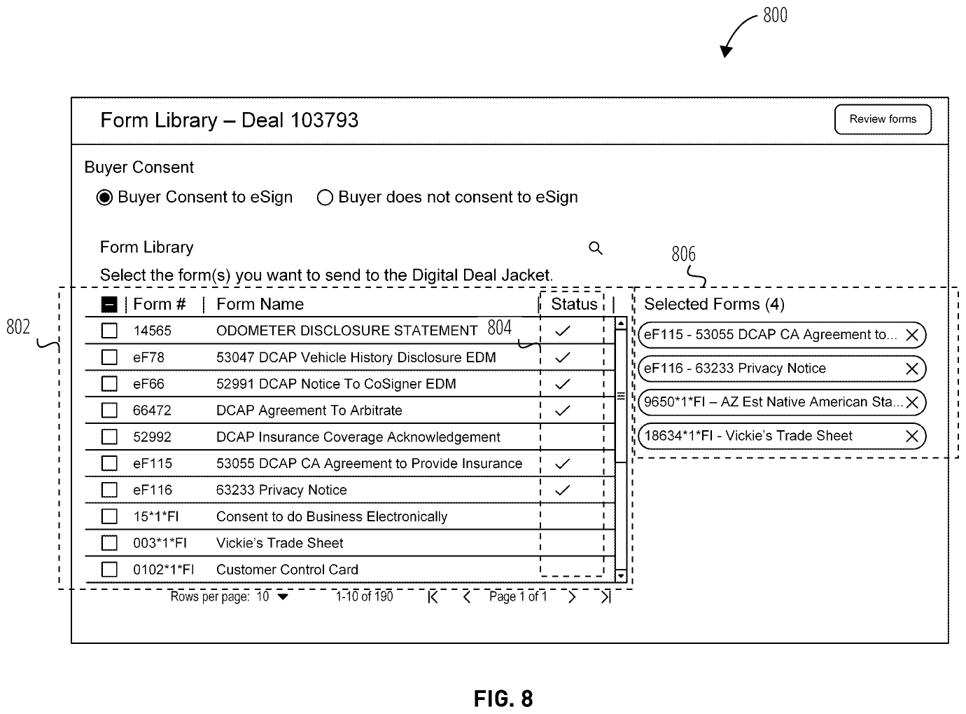

FIG. 8 illustrates a form library GUI 800 that may be displayed to a user of the DMS 314, according to an embodiment. The form library GUI 800 may allow the user to select one or more forms to be used as part of a DDJ. A forms listing 802 may detail the forms that can be selected by the user. The form library GUI 800 may be generated by the cloud service platform 304. The form library GUI 800 may be a combined list that includes information about forms stored in the forms store 318 on the DMS 314 (where this information may be provided from the DMS 314 to the cloud service platform 304) and forms on the forms database 310 (as determined based on communications between the forms database 310 and the cloud service platform 304).

As part of the of the forms listing 802, status indicators 804 corresponding to each of the forms may relate whether the form has already been successfully generated/filled, whether no action has yet been taken to generate/fill a form, whether there was an issue with a previous attempt to generate/fill a form, etc.

Once selected from the forms listing 802, the forms may be added to the selected forms list 806. These are forms that the system 300 will attempt to generate/fill. For each of the forms in the selected forms list 806, the system 300 may fill one or more fields in forms that are defined at the DMS 314 and/or the cloud service platform 304, as described herein. To the extent that the necessary field data is not found in the DMS 314 and/or the cloud service platform 304 per those field definitions, the system 300 may prompt the user for this field data, as described herein.

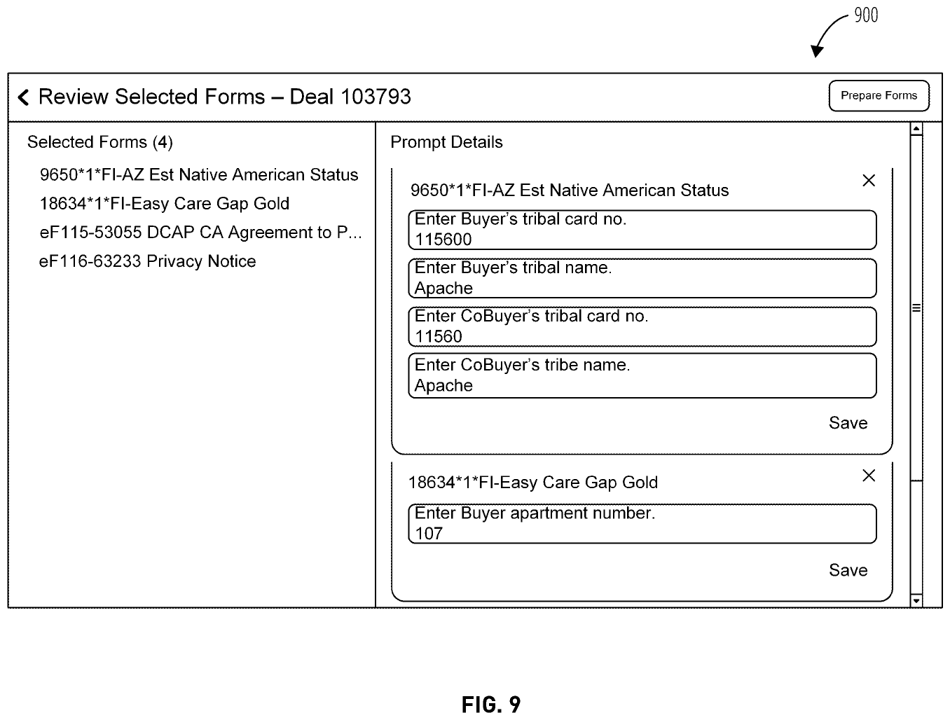

FIG. 9 illustrates a DMS prompt GUI 900 that may displayed to a user of the DMS 314, according to an embodiment. In the event that a form is used (e.g., selected as in FIG. 8) that uses one or more fields stored at the DMS 314 and for which appropriate field data has not yet been provided at the DMS 314, the cloud service platform 304 may use the DMS prompt GUI 900 to prompt the user for the information for those fields, as illustrated. For example, the DMS 314 may communicate to the cloud service platform 304 that is missing the necessary field data. The cloud service platform 304 may respond by generating the DMS prompt GUI 900 and presenting it to the user of the first user device 306 via the DMS 314. Once the user provides the input, it may be returned from the cloud service platform 304 to the DMS 314 and stored within the DMS 314.

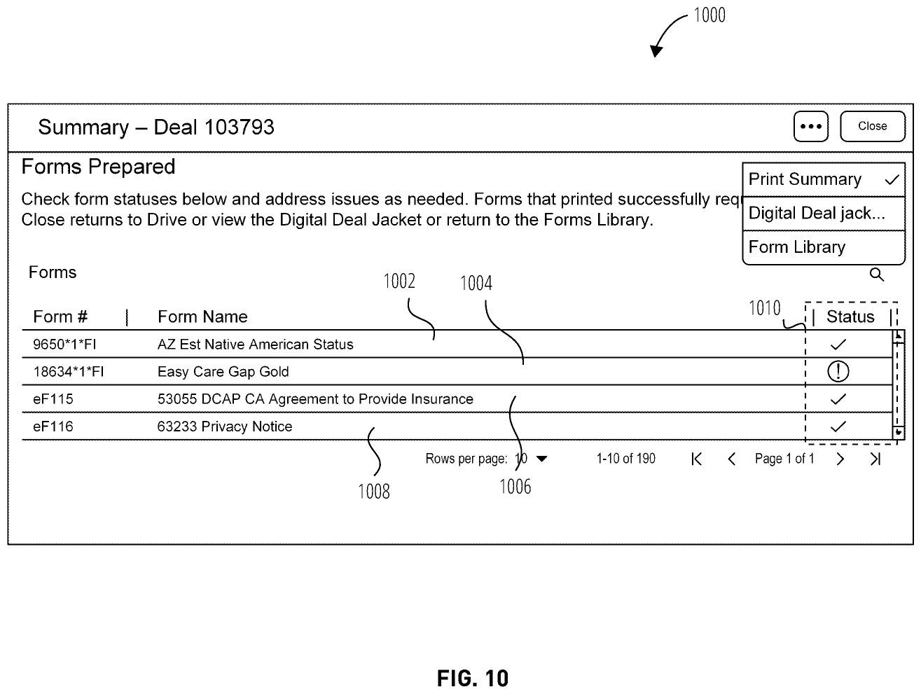

FIG. 10 illustrates a form preparation summary GUI 1000, according to an embodiment. The form preparation summary GUI 1000 corresponds to the first form 1002, the second form 1004, the third form 1006, and the fourth form 1008 that were selected per the selected forms list 806 of FIG. 8.

As can be seen in reference to the status indicators 1010, the first form 1002, the third form 1006, and the fourth form 1008 were successfully prepared. Further, per the status indicators 1010, the second form 1004 was not successfully prepared.

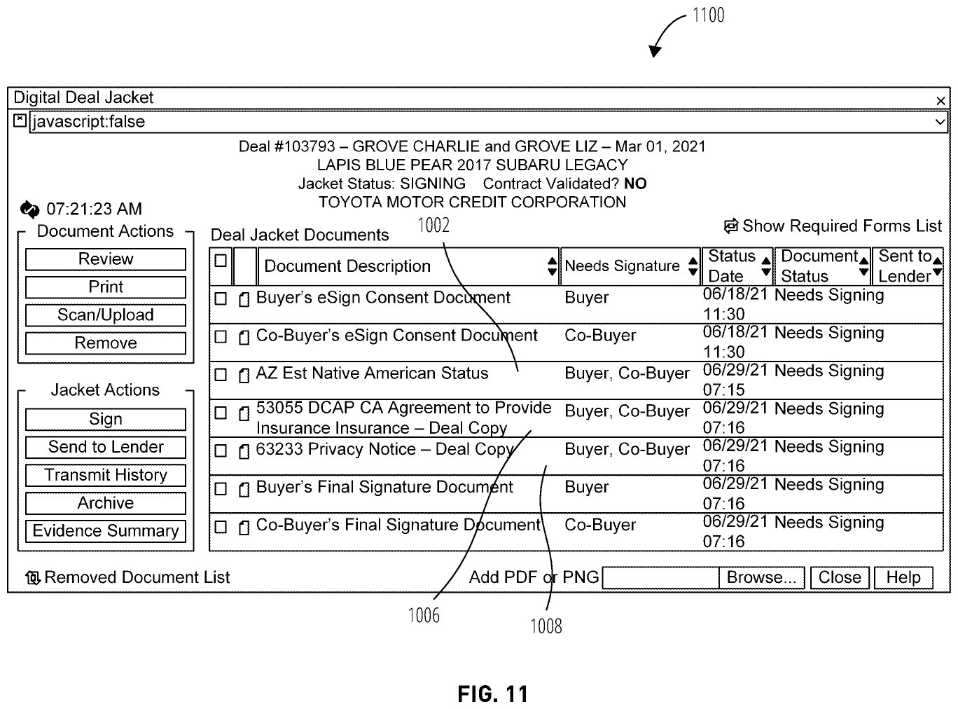

Any successfully prepared forms may in some embodiments, be added to a DDJ. FIG. 11 illustrates a DDJ 1100 generated at a print service 312, according to an embodiment. The DDJ 1100 is a modified version of the DDJ 200 of FIG. 2. As can be seen, the first form 1002, the third form 1006, and the fourth form 1008 (which were successfully prepared as described) are now present in the DDJ 1100.

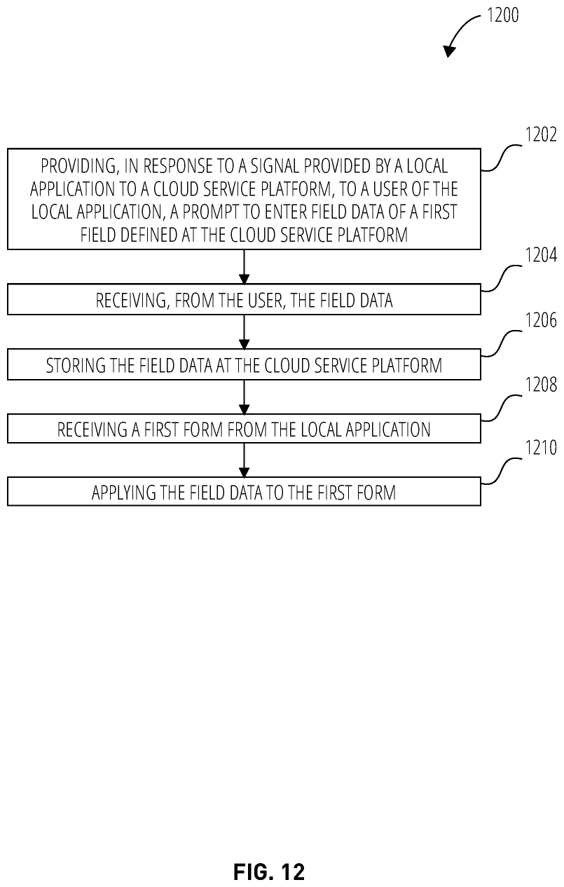

FIG. 12 illustrates a method 1200 of a cloud service platform for integrating with a local application operating on a remote device, according to an embodiment. The method 1200 includes providing, in response to a signal provided by the local application to the cloud service platform, to a user of the local application, a prompt to enter field data of a first field defined at the cloud service platform.

The method 1200 further includes receiving, from the user, the field data.

The method 1200 further includes storing the field data at the cloud service platform.

The method 1200 further includes receiving a first form from the local application.

The method 1200 further includes applying the field data to the first form.

In some embodiments, the method 1200 further includes receiving a second form from a forms database and applying the field data to a second form. In some of these embodiments, the method 1200 further includes providing the first form and the second form to a print service.

In some embodiments, the method 1200 further includes receiving a second form from the local application and applying the field data to the second form. In some of these embodiments, the method 1200 further includes providing the first form and the second form to a print service.

In some embodiments of the method 1200, the prompt to enter the field data is organized according to a domain of the first field.

In some embodiments, the method 1200 further includes recording that the field data was applied to the first form in telemetry data for the cloud service platform.

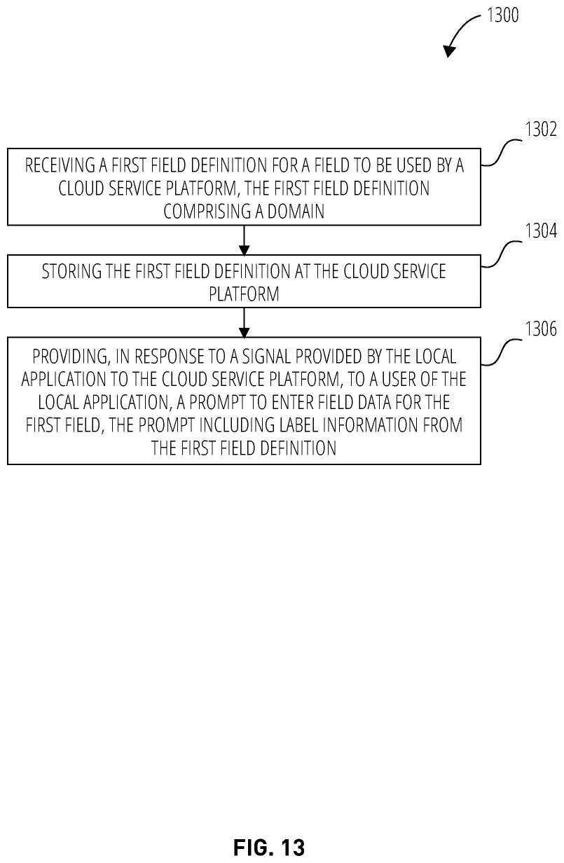

FIG. 13 illustrates a method 1300 of a cloud service platform for integrating with a local application operating on a remote device, according to an embodiment. The method 1300 includes receiving a first field definition for a field to be used by the cloud service platform, the first field definition comprising a domain.

The method 1300 further includes storing the first field definition at the cloud service platform.

The method 1300 further includes providing, in response to a signal provided by the local application to the cloud service platform, to a user of the local application, a prompt to enter field data for the first field, the prompt including label information from the first field definition.

In some embodiments of the method 1300, the first field definition further comprises metadata, and wherein the metadata for the first field definition is displayed within the prompt to enter field data for the first field.

In some embodiments of the method 1300, the prompt to enter the field data is organized according to the domain of the first field.

In some embodiments of the method 1300, the domain is a domain recognized by the local application.

In some embodiments, the method 1300 further includes receiving, from the local application, the field data; and storing the field data at the cloud service platform.

In some embodiments, the method 1300 further includes receiving, from the local application, the field data; and applying the field data to a form.

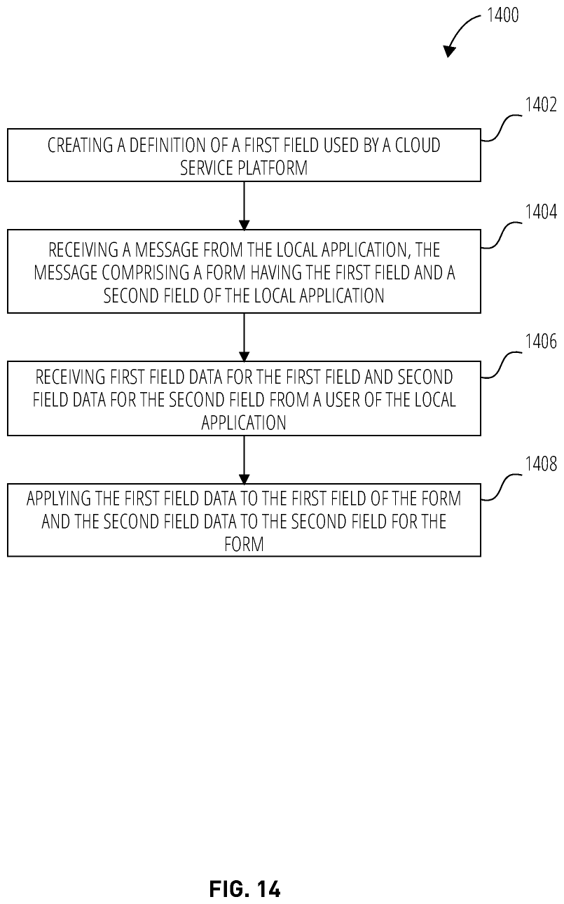

FIG. 14 comprises a method 1400 of a cloud service platform for integrating with a local application operating on a remote device, according to an embodiment. The method 1400 includes creating a definition of a first field used by a cloud service platform.

The method 1400 further includes receiving a message from the local application, the message comprising a form having the first field and a second field of the local application.

The method 1400 further includes receiving first field data for the first field and second field data for the second field from a user of the local application

The method 1400 further includes applying the first field data to the first field of the form and the second field data to the second field for the form

In some embodiments of the method 1400, the first field data for the first field is applied to the form according to a workflow for the form, the workflow being provided to the cloud service platform by the local application.

In some embodiments of the method 1400, a field management engine of the cloud service platform stores the definition for the first field in a field definition service of the cloud service platform. In some of these embodiments, the field definition service of the cloud service platform provides the definition for the first field to a telemetry service of the cloud service platform.

In some embodiments of the method 1400, a field bridge engine of the cloud service platform stores the first field data for the first field in a field data service of the cloud service platform. In some of these embodiments, the field data service is to indicate to a telemetry service of the cloud service platform that the first field has been used.

In some embodiments of the method 1400, a field bridge engine of the cloud service platform is launched in response to a signal made by a bridge launcher of the local application.

The systems disclosed herein may include one or more processors and/or controllers using instructions present thereon to implement one or more functionalities of each such power adapter as those functionalities are described herein. The instructions used by such processors and/or controllers may be stored on a non-transitory computer-readable storage medium on (or in communication with) such controllers and/or processors. It is anticipated that these processors and/or controllers (and associated non-transitory computer-readable instructions for use thereon) may be present in any embodiment disclosed herein (even if not explicitly discussed).

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

1. A method of a cloud service platform for integrating with a local application operating on a remote device, comprising:
receiving a first field definition for a field to be used by the cloud service platform, the first field definition comprising a domain;
storing the first field definition at the cloud service platform; and
providing, in response to a signal provided by the local application to the cloud service platform, to a user of the local application, a prompt to enter field data for the first field, the prompt including label information from the first field definition.

2. The method of claim 1, wherein the first field definition further comprises metadata, and wherein the metadata for the first field definition is displayed within the prompt to enter field data for the first field.

3. The method of claim 1, wherein the prompt to enter the field data is organized according to the domain of the first field.

4. The method of claim 1, wherein the domain is a domain recognized by the local application.

5. The method of claim 1, further comprising:
receiving, from the local application, the field data; and
storing the field data at the cloud service platform.

6. The method of claim 1, further comprising:
receiving, from the local application, the field data; and
applying the field data to a form.

7. The method of claim 1, wherein providing the prompt comprises providing a graphical user interface (GUI) configured to act as the prompt on a screen coupled to the remote device.

8. A system comprising:
a remote device configured to operate a local application;
a cloud service platform integrated over a network with the local application operating on the remote device, comprising:
one or more processors; and
a non-transitory computer-readable storage medium storing instructions that, when executed by the one or more processors, configure the one or more processors to perform, for the cloud service platform:
receiving a first field definition for a field to be used by the cloud service platform, the first field definition comprising a domain;
storing the first field definition at the cloud service platform; and
providing, in response to a signal provided by the local application to the cloud service platform, to a user of the local application, a prompt to enter field data for the first field, the prompt including label information from the first field definition.

9. The system of claim 8, wherein the first field definition further comprises metadata, and wherein the metadata for the first field definition is displayed within the prompt to enter field data for the first field.

10. The system of claim 8, wherein the prompt to enter the field data is organized according to the domain of the first field.

11. The system of claim 8, wherein the domain is a domain recognized by the local application.

12. The system of claim 8, wherein the instructions further configure the one or more processors to perform:
receiving, from the local application, the field data; and
storing the field data at the cloud service platform.

13. The system of claim 8, wherein the instructions further configure the one or more processors to perform:
receiving, from the local application, the field data; and
applying the field data to a form.

14. The system of claim 8, wherein providing the prompt comprises providing a graphical user interface configured to act as the prompt on a screen coupled to the remote device.

15. A non-transitory computer-readable storage medium, the computer-readable storage medium including instructions that when executed by one or more processors, cause the one or more processors to perform:
receiving a first field definition for a field to be used by the cloud service platform, the first field definition comprising a domain;
storing the first field definition at the cloud service platform; and
providing, in response to a signal provided by the local application to the cloud service platform, to a user of the local application, a prompt to enter field data for the first field, the prompt including label information from the first field definition.

16. The non-transitory computer-readable storage medium of claim 15, wherein the first field definition further comprises metadata, and wherein the metadata for the first field definition is displayed within the prompt to enter field data for the first field.

17. The non-transitory computer-readable storage medium of claim 15, wherein the prompt to enter the field data is organized according to the domain of the first field.

18. The non-transitory computer-readable storage medium of claim 15, wherein the domain is a domain recognized by the local application.

19. The non-transitory computer-readable storage medium of claim 15, wherein the instructions further configure the one or more processors to perform:
receiving, from the local application, the field data; and
storing the field data at the cloud service platform.

20. The non-transitory computer-readable storage medium of claim 15, wherein the instructions further configure the one or more processors to perform:
receiving, from the local application, the field data; and
applying the field data to a form.
